(19) United States
(12) Patent Application Publication
(10) Pub. No.: US 2025/0138344 A1
(43) Pub. Date: May 1, 2025

(54) ELECTRO-OPTIC DISPLAY WITH AN ELECTRO-OPTIC MATERIAL LAYER HAVING A BINDER COMPRISING A POLYMER WITH A QUATERNARY AMMONIUM GROUP AND A METHOD FOR MANUFACTURING SAME

(71) Applicant: E INK CORPORATION, Billerica, MA (US)

(72) Inventors: Rosa CASADO, Middleton, MA (US); Sergey EGOROV, Nashua, NH (US)

(21) Appl. No.: 18/922,749

(22) Filed: Oct. 22, 2024

Related U.S. Application Data
(60) Provisional application No. 63/546,376, filed on Oct. 30, 2023.

(51) Int. Cl. G02F 1/00; C09D 5/14; C09D 7/40; C09D 129/04; G02F 1/167; G02F 1/16757; G02F 1/1676

(52) U.S. Cl. CPC G02F 1/0018; C09D 5/14; C09D 7/70; C09D 129/04; G02F 1/167; G02F 1/16757; G02F 1/1676

(57) ABSTRACT

An electro-optic display comprises an electro-optic material layer, the electro-optic material layer comprising an electrophoretic medium encapsulated in a plurality of microcapsules dispersed in a binder. The binder of the electro-optic material layer comprises a polymer containing one or more quaternary ammonium functional groups in its molecular structure. The binder provides antimicrobial protection and enables improved electro-optic performance and an efficient and robust method of manufacturing the electro-optic display.

### RELATED APPLICATIONS

This application claims priority to U.S. Provisional Patent Application No. 63/546,376 filed on Oct. 30, 2023, which is incorporated by reference in its entirety, along with all other patents and patent applications disclosed herein.

### FIELD OF THE INVENTION

The present invention relates to an electro-optic display comprising an electro-optic material layer, the electro-optic material layer comprising an electrophoretic medium encapsulated in a plurality of microcapsules dispersed in a binder. The binder of the electro-optic material layer comprises a polymer containing one or more quaternary ammonium functional groups in its molecular structure. The polymer of the binder enables improved electro-optic performance and an efficient and robust method for manufacturing of the electro-optic display.

### BACKGROUND OF THE INVENTION

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Particle-based electrophoretic displays have been the subject of intense research and development for a number of years. In this type of display, a plurality of charged pigment particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, pigment particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Patent Publication No. 2005/0001810; European Patent Applications 1,462,847; 1,482,354; 1,484,635; 1,500,971; 1,501,194; 1,536,271; 1,542,067; 1,577,702; 1,577,703; and 1,598,694; and International Applications WO 2004/090626; WO 2004/079442; and WO 2004/001498. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the charged pigment particles of the electrophoretic medium.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile charged pigment particles suspended in a liquid suspending medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,724,519; 6,727,881; 6,738,050; 6,750,473; 6,753,999; 6,816,147; 6,819,471; 6,822,782; 6,825,068; 6,825,829; 6,825,970; 6,831,769; 6,839,158; 6,842,167; 6,842,279; 6,842,657; 6,864,875; 6,865,010; 6,866,760; 6,870,661; 6,900,851; 6,922,276; 6,950,200; 6,958,848; 6,967,640; 6,982,178; 6,987,603; 6,995,550; 7,002,728; 7,012,600; 7,012,735; 7,023,430; 7,030,412; 7,030,854; 7,034,783; 7,038,655; 7,061,663; 7,071,913; 7,075,502; 7,075,703; 7,079,305; 7,106,296; 7,109,968; 7,110,163; 7,110,164; 7,116,318; 7,116,466; 7,119,759; and 7,119,772; and U.S. Patent Applications Publication Nos. 2002/0060321; 2002/0090980; 2002/0180687; 2003/0011560; 2003/0102858; 2003/0151702; 2003/0222315; 2004/0014265; 2004/0075634; 2004/0094422; 2004/0105036; 2004/0112750; 2004/0119681; 2004/0136048; 2004/0155857; 2004/0180476; 2004/0190114; 2004/0196215; 2004/0226820; 2004/0239614; 2004/0257635; 2004/0263947; 2005/0000813; 2005/0007336; 2005/0012980; 2005/0017944; 2005/0018273; 2005/0024353; 2005/0062714; 2005/0067656; 2005/0078099; 2005/0099672; 2005/0122284; 2005/0122306; 2005/0122563; 2005/0122565; 2005/0134554; 2005/0146774; 2005/0151709; 2005/0152018; 2005/0152022; 2005/0156340; 2005/0168799; 2005/0179642; 2005/0190137; 2005/0212747; 2005/0213191; 2005/0219184; 2005/0253777; 2005/0270261; 2005/0280626; 2006/0007527; 2006/0024437; 2006/0038772; 2006/0139308; 2006/0139310; 2006/0139311; 2006/0176267; 2006/0181492; 2006/0181504; 2006/0194619; 2006/0197736; 2006/0197737; 2006/0197738; 2006/0198014; 2006/0202949; and 2006/0209388; and International Applications Publication Nos. WO 00/38000; WO 00/36560; WO 00/67110; and WO 01/07961; and European Patents Nos. 1,099,207 B1; and 1,145,072 B1.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged pigment particles and the suspending fluid are not encapsulated within microcapsules but instead are retained within a plurality of cavities formed within a carrier medium, typically a polymeric film. See, for example, International Application Publication No. WO 02/01281, and published US Application No. 2002/0075556, both assigned to Sipix Imaging, Inc.

Although electrophoretic media are often opaque (since, for example, in many electrophoretic media, the charged pigment particles substantially block transmission of visible light through the display) and operate in a reflective mode, many electrophoretic displays can be made to operate in a so-called “shutter mode” in which one display state is substantially opaque and one is light-transmissive. See, for example, the aforementioned U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

Electro-optic displays, which comprise electrophoretic media that are encapsulated in microcapsules, require the use of a polymeric binder in order to be able to form a coherent layer that could be disposed between two electrodes. Typically, a plurality of microcapsules is mixed with a binder to form an aqueous microcapsule slurry. A binder that is commonly used in the aqueous microcapsule slurry comprises anionic polyurethane. The aqueous microcapsule slurry is then coated and dried/cured to form an electro-optic material layer. Special attention needs to be paid to prevent microbial growth, if the aqueous microcapsule slurry is stored at room temperature before its use, because typical microcapsule walls comprise gelatin. Because of its proteinaceous nature, gelatin may be readily degraded by proteases that are produced by growing bacterial or fungi in aqueous microcapsule slurries. Mitigation of such degradation may be achieved (a) by storing of the aqueous microcapsule slurry in the refrigerator at low temperatures, (b) by using the aqueous microcapsule slurry only a short time after its preparation, or (c) by including a biocide into the aqueous microcapsule slurry. However, storing the aqueous microcapsule slurry in a refrigerator and/or using it shortly after its preparation is not only inconvenient, but also increases the cost of manufacturing. Although inclusion of a biocide into the aqueous microcapsule slurry mitigates the development of microbes, the inventors of the present invention observed that biocides require high (or low) pH to be functional or the biocides may affect the pH over time, resulting in high or low pH of the aqueous microcapsule slurry during storage. However, storage of microcapsules in aqueous media at high (or low) pH may lead to hydrolysis of the microcapsule walls. In addition, because biocides are typically small organic molecules, they can migrate from the continuous phase of the aqueous microcapsule slurry (or the continuous phase of the electrophoretic layer of the display) into the microcapsules and/or other layers of the electro-optic display, resulting in a detrimental effect to the electro-optic performance of the corresponding display. Thus, it is desirable to eliminate the use of traditional biocides from aqueous microcapsule compositions and to develop aqueous microcapsule slurry compositions that enable their long term storage. It is also desirable to be able to utilize convenient and cost effective processes for manufacturing the corresponding electro-optic displays. The inventors of the present invention surprisingly found that the use of binders comprising a polymer containing one or more quaternary ammonium functional groups in its molecular structure provides multiple benefits. Not only such binders provide antimicrobial activity, as opposed to other binders comprising an anionic or nonionic polyurethane, but they also provide (i) a mechanically robust electro-optic material layer and (ii) an electro-optic display that shows improved electro-optic performance.

### SUMMARY OF THE INVENTION

In one aspect, the present invention provides an electro-optic display comprising, in order, a first electrode layer, an electro-optic material layer, and a second electrode layer. The first electrode layer comprises a light-transmissive electrode. The electro-optic material layer comprises a plurality of microcapsules dispersed in a binder. Each microcapsule of the plurality of microcapsules comprises an electrophoretic medium, the electrophoretic medium comprising a plurality of charged pigment particles and a non-polar liquid. The binder comprises a polymer containing one or more quaternary ammonium functional groups in its molecular structure. The second electrode layer comprises a plurality of pixel electrodes. The electro-optic display may further comprise a first adhesive layer disposed between the electro-optic material layer and the second electrode layer. The electro-optic display may further comprise a second adhesive layer disposed between the electro-optic material layer and the first electrode layer. The electro-optic material layer may further comprise a biocide. The electro-optic material layer may be substantially free from biocide.

The binder may comprise a poly(vinyl alcohol) containing one or more quaternary ammonium functional groups in its molecular structure. The weight average molecular weight of the poly(vinyl alcohol) may be from 1,000 to 1,000,000 Daltons, or from 10,000 to 1,000,000 Daltons. The poly(vinyl alcohol) may be crosslinked. The poly(vinyl alcohol) may contain from 0.03 to 0.4, or from 0.05 to 0.2 quaternary ammonium functional groups for every vinyl alcohol unit of the polymer. The hydrolysis number of the poly(vinyl alcohol) may be from 80 to 99.5 or from 86 to 98. The poly(vinyl alcohol) may be soluble in water.

The binder may comprise a polyurethane containing one or more quaternary ammonium functional groups in its molecular structure. The weight average molecular weight of the polyurethane may be from 1,000 to 2,000,000 Daltons. The polyurethane may be crosslinked. The polyurethane may contain from 1 to 6, or from 2 to 4 quaternary ammonium functional groups for every polyol unit of the polymer. The polyurethane may be crosslinked. The polyurethane may be soluble or dispersible in water. The polyurethane may be selected from the group consisting of polyether polyurethane, polyester polyurethane, and polycarbonate polyurethane.

The electro-optic material layer may comprise from 85 weight percent to 97 weight percent microcapsules, and from 15 weight percent to 3 weight percent binder by weight of the electro-optic material layer. The electrophoretic medium may comprise four types of charged pigment particles, a first type of charged pigment particles, a second type of charged pigment particles, a third type of charged pigment particles, and a fourth type of charged pigment particles. Each type of charged pigment particles may have a color that is different from the colors of all other types of charged pigment particles. The electrophoretic medium may further comprise a fifth type of charged pigment particles. The colors of the first, second, third, and fourth charged pigment particles may be selected from the group consisting of white, black, yellow, cyan, magenta, green, blue, and red. The first type of charged pigment particles may be negatively charged, and the second, third, and fourth types charged pigment particles may be positively charged. Alternatively, the first and second types of charged pigment particles may be negatively charged, and the third and fourth types of charged pigment particles may be positively charged.

In another aspect, the present invention provides a method of manufacturing an electro-optic display, the method of manufacturing comprising the steps: (a) providing an aqueous dispersion of a plurality of microcapsules, each microcapsule of the plurality of microcapsules comprising an electrophoretic medium, the electrophoretic medium comprising a plurality of charged pigment particles, and a non-polar liquid; (b) mixing an aqueous binder solution or dispersion into the aqueous dispersion of a plurality of microcapsules forming an aqueous microcapsule slurry, the binder solution or dispersion comprising a polymer containing one or more quaternary ammonium functional groups in its molecular structure; (c) providing a first electrode layer comprising a light-transmissive electrode, the first electrode layer having a surface; (d) applying the aqueous microcapsule slurry onto the surface of the first electrode layer to form an aqueous microcapsule layer; (e) drying the aqueous microcapsule layer to form an electro-optic material layer on the first electrode layer; (g) applying an adhesive composition onto the electro-optic material layer to form an adhesive layer, the electro-optic material layer being disposed between the first electrode layer and the adhesive layer; (h) connecting a release sheet onto the adhesive layer to form a Front Plane Laminate, the adhesive layer in the Front Plane Laminate being disposed between the electro-optic material layer and the release sheet; (i) removing the release sheet, exposing the adhesive layer; and (k) attaching a backplane onto the exposed surface of the adhesive layer, the backplane comprising a second electrode layer.

### BRIEF DESCRIPTION OF DRAWINGS

FIG. 1 illustrates a side view of a portion of an electro-optic display of the present invention comprising a first electrode layer, an electro-optic material layer, an adhesive layer, and a second electrode layer.

FIG. 2 illustrates a side view of a portion of an electro-optic display of the present invention comprising a first electrode layer, a second adhesive layer, an electro-optic material layer, a first adhesive layer, and a second electrode layer.

FIGS. 3A and 3B illustrate an example of a method of manufacturing of the electro-optic display of the present invention via a Front Plane Laminate.

FIG. 4 shows a graph of the color gamut of color electro-optic displays at two different times; the color electro-optic displays were constructed from microcapsules, which were formed from various aqueous microcapsule slurries.

### DETAILED DESCRIPTION OF THE INVENTION

The term “molecular weight” or “MW” as used herein refers to the weight average molecular weight, unless otherwise stated. The weight average molecular weight may be measured by gel permeation chromatography.

The term “substantially free from biocide” referring to an electro-optic material layer, means that the electro-optic material layer contains less than 0.0001 weight percent of biocide by weight of the electro-optic material layer or less than 0.001 weight percent of biocide by weight of the electro-optic material layer or less than 0.01 weight percent of biocide by weight of the electro-optic material layer. For purposes of the present application, a polymer containing one or more quaternary ammonium functional groups is not regarded as biocide.

The degree of hydrolysis of a poly(vinyl alcohols) is routinely reported by manufactures of such polymer and it indicates the proportion by units (moles) of vinyl alcohol in the polymer to the total vinyl units. The other units are typically vinyl acetate (ester groups).

A compound is “soluble” in a liquid, if at least 1 gram of the compound can be dissolved in 100 grams of the liquid.

Quaternary ammonium functional group, also known as quat group, is a cationic polyatomic functional group having a nitrogen atom, the nitrogen atom being covalently bonded with four carbon atoms, each of the four carbon atoms being part of a functional groups, wherein the functional groups may be independently selected from alkyl, aryl, or other organic functional groups.

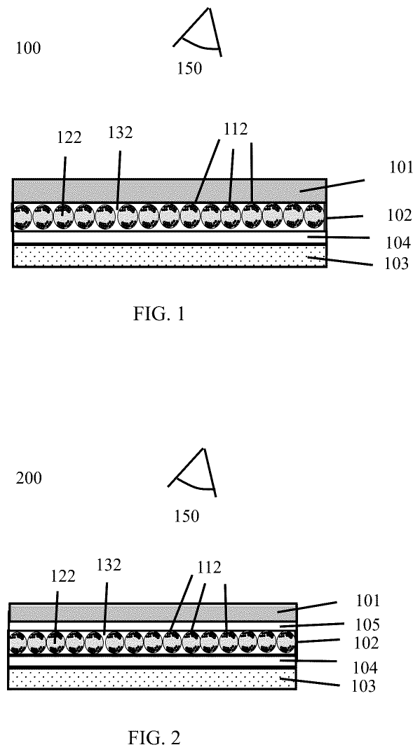

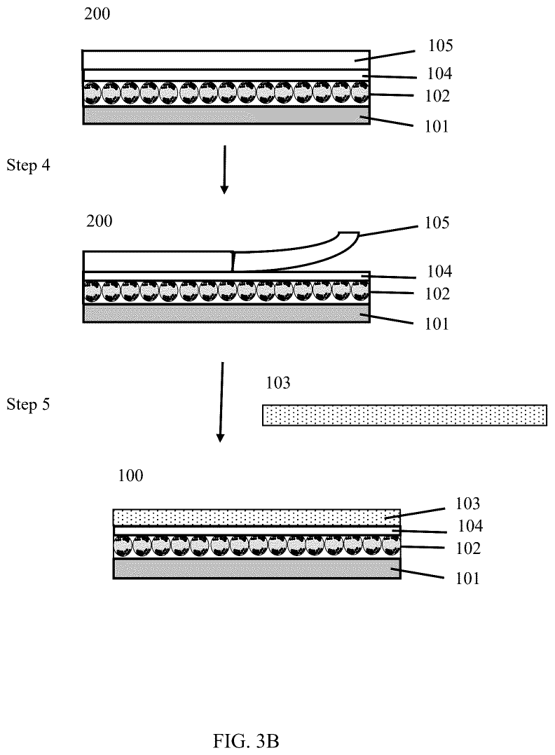

A typical electro-optic display may have an electro-optic material layer that comprises an electrophoretic medium, which is encapsulated in microcapsules or microcells, as described in U.S. Pat. No. 6,982,178. FIG. 1 shows a side view of a portion of an electro-optic display having microcapsules. Electro-optic display 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 102 comprises a plurality of microcapsules 112 and a binder 132. Each microcapsule has a microcapsule wall. Each microcapsule includes electrophoretic medium 122 having charge pigment particles in a non-polar liquid. Electrophoretic medium 122 may comprise a plurality of first type of charged pigment particles and a plurality of second type of charged pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Typically, the plurality of microcapsules are retained within a polymeric binder 132. A viewer can view the image of electro-optic display 100 from the viewing side 150. The electro-optic display 100 may be constructed from a front plane laminate, as described in the background of the invention and summarized in FIGS. 3A and 3B. The electro-optic of FIG. 1 may be a color electro-optic display, which means that it can display images comprising a variety of colors.

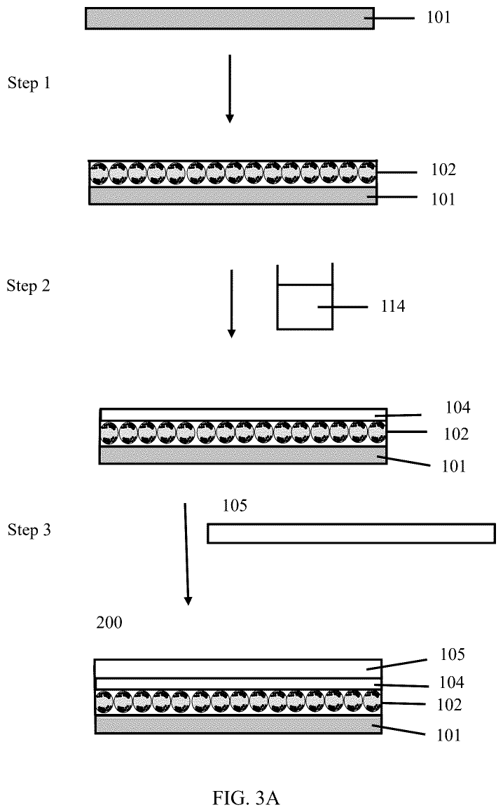

Another example of an electro-optic display is shown in FIG. 2. FIG. 2 illustrates a side view of a portion of an electro-optic display having microcapsules. Electro-optic display 200 has a viewing side 150. It comprises, in order, a first electrode layer 101 comprising a light transmissive electrode, a second adhesive layer 105, an electro-optic material layer 102, a first adhesive layer 104, and a second electrode layer 103, the second electrode layer comprising a plurality of pixel electrodes. The second adhesive layer 105 connects first electrode layer 101 with electro-optic material layer 102. The first adhesive layer 104 connects the electro-optic material layer 102 with the second electrode layer 103. The electro-optic material layer 102 comprises a plurality of microcapsules 112 and binder 132. Each microcapsule has a microcapsule wall and includes electrophoretic medium 122 having charge pigment particles in a non-polar liquid. Electrophoretic medium 122 may comprise a plurality of first type of charged pigment particles and a plurality of second type of charged pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Typically, the plurality of microcapsules are retained within a polymeric binder 132. The electro-optic material layer 100 may be constructed from a double release sheet as described in the background of the invention. The electro-optic of FIG. 2 may be a color display, which means that it can display images comprising a variety of colors.

The microcapsule electro-optic displays of FIGS. 1 and 2 may further comprise a light transmissive front substrate (not shown in FIGS. 1 and 2), which is adjacent to the first electrode layer 101, wherein the electrode layer is disposed between the front substrate and the electro-optic material layer (for the display of FIG. 1) or between the front substrate and the second adhesive layer (for the display of FIG. 2). The front substrate may be a plastic film, such as a sheet of poly(ethylene terephthalate) (PET) having thickness of from 25 to 200 μm. Front substrate may further comprise one or more additional layers, for example, a protective layer to absorb ultra violet radiation, barrier layers to prevent ingress of oxygen or moisture into the display, and anti-reflection coatings to improve the optical properties of the display.

The electro-optic material layer of a microcapsule electro-optic display comprises a binder, in addition to microcapsules comprising an electrophoretic medium. The binder comprises a polymer, which contributes to a mechanically robust electro-optic material layer of the electro-optic display. A typical process for forming the electro-optic material layer involves mixing an aqueous microcapsule dispersion with an aqueous binder solution or dispersion. This aqueous composition is herein also called aqueous microcapsule slurry or microcapsule slurry. During the manufacture of an electro-optic display, this aqueous microcapsule slurry is coated onto a surface, followed by drying or curing of the aqueous coating to form the electro-optic material layer. That is, the electro-optic material layer typically comprises a monolayer of microcapsules within a binder.

The binder of the electro-optic material layer of the present invention comprises a polymer containing one or more quaternary ammonium functional groups in its molecular structure. That is, the binder comprises a polymer having cationic functional groups. Nonlimiting polymers include poly(vinyl alcohol), polyurethane, acrylate, and methacrylate polymers containing one or more quaternary ammonium functional groups in the molecular structure.

The binder may comprise a poly(vinyl alcohol) containing one or more quaternary ammonium functional groups in its molecular structure. The weight average molecular weight of the poly(vinyl alcohol) may be from 1,000 to 1,000,000 Daltons, from 5,000 to 800,000 Daltons, from 10,000 to 700,000 Daltons, or from 15,000 to 600,000 Daltons. The poly(vinyl alcohol) of the binder may be crosslinked or not crosslinked. The poly(vinyl alcohol) of the binder may be soluble in water. The degree of hydrolysis of the poly(vinyl alcohol) of the binder may be from 70 to 99.5, from 80 to 99, from 86 to 98, or from 88 to 95.

The poly(vinyl alcohol) may contain from 2 to 2,000, 10 to 1,500, 100 to 1,200, or 500 to 1,000 quaternary ammonium functional groups in its molecular structure. The poly(vinyl alcohol) of the binder may contain from 0.03 to 0.4, from 0.04 to 0.3, of from 0.05 to 0.2 quaternary ammonium functional groups for every vinyl alcohol unit of the polymer. The nitrogen content of the poly(vinyl alcohol) of the binder may be from 0.2 weight % to 12 weight %, from 0.5 weight % to 10 weight %, from 0.7 weight % to 9 weight %, or from 1.0 weight % to 8 weight % of nitrogen by weight of the poly(vinyl alcohol).

The binder may comprise a polyurethane containing one or more quaternary ammonium functional groups in its molecular structure. The weight average molecular weight of the polyurethane may be from 1,000 to 2,000,000 Daltons, from 5,000 to 1,500,000 Daltons, from 10,000 to 1,000,000 Daltons, or from 15,000 to 800,000 Daltons. The polyurethane of the binder may be crosslinked or not crosslinked. The polyurethane of the binder may be soluble in water or dispersible in water. The polyurethane may contain from 2 to 2,000, 10 to 1,500, 100 to 1,200, or 500 to 1,000 quaternary ammonium functional groups in its molecular structure. The polyurethane of the binder may contain from 0.03 to 0.4, from 0.04 to 0.3, of from 0.05 to 0.2 quaternary ammonium functional groups for every polyol unit of the polymer. The nitrogen content of the polyurethane of the binder that is part of the quaternary ammonium functional groups of the polymer may be from 0.2 weight % to 12 weight %, from 0.5 weight % to 10 weight %, from 0.7 weight % to 9 weight %, or from 1.0 weight % to 8 weight % of nitrogen by weight of the polyurethane.

The binder may comprise a polyacrylate or polymethacrylate containing one or more quaternary ammonium functional groups in its molecular structure. The weight average molecular weight of the polyurethane may be from 1,000 to 2,000,000 Daltons, from 5,000 to 1,500,000 Daltons, from 10,000 to 1,000,000 Daltons, or from 15,000 to 800,000 Daltons. The polyurethane of the binder may be crosslinked or not crosslinked. The polyacrylate or polymethacrylate of the binder may be soluble in water or dispersible in water. The a polyacrylate or polymethacrylate may contain from 2 to 2,000, 10 to 1,500, 100 to 1,200, or 500 to 1,000 quaternary ammonium functional groups in its molecular structure. The polyacrylate or polymethacrylate of the binder may contain from 0.03 to 0.4, from 0.04 to 0.3, of from 0.05 to 0.2 quaternary ammonium functional groups for every monomer unit of the polymer. The nitrogen content of the polyacrylate or polymethacrylate of the binder that is part of the quaternary ammonium functional groups of the polymer may be from 0.2 weight % to 12 weight %, from 0.5 weight % to 10 weight %, from 0.7 weight % to 9 weight %, or from 1.0 weight % to 8 weight % of nitrogen by weight of the polyacrylate or polymethacrylate.

The binder of the electro-optic material layer of the inventive electro-optic display may comprise a combination of polymers. The polymer of the binder may be selected from the group consisting of poly(vinyl alcohol), polyurethane, polyacrylate, polymethacrylate, polyurea, and combinations thereof.

The binder of the electro-optic material layer of the inventive electro-optic display may be substantially free from biocide. Alternatively, the electro-optic material layer of the inventive electro-optic display may comprise a biocide. The content of the biocide of the electro-optic material layer may be from 0.2 to 10 weight percent by weight of the electro-optic material layer, or from 1 to 8 weight percent, or from 2 to 6 weight percent by weight of the electro-optic material layer. Nonlimiting examples of biocides include isothiazolinones, tetrahydromethyl phosphonium sulfate (THPS), 2,2-dibromo-3-nitrilopropionamide, bronopol and mixtures thereof.

As mentioned above, microcapsules may be prepared in an aqueous medium and then mixed with a binder aqueous solution or dispersion to make an aqueous microcapsule slurry. The aqueous microcapsule slurry comprising the cationic polymer of the present invention is less prone to microbial growth during its storage. Furthermore, the electro-optic material layer of the inventive electro-optic display may not include a traditional biocide, which, because it is a small molecule, has the tendency to diffuse through the layer of the electro-optic display, negatively affecting the electro-optic performance of the display. The absence of the traditional biocide from the electro-optic material layer of the inventive electro-optic display enables the formation of the electro-optic material layer from aqueous microcapsule slurries having neutral pH, avoiding problems of microcapsule hydrolysis that is observed in electro-optic material layer which are formed by aqueous microcapsule slurries having at alkali or acidic pH values.

The electrophoretic medium, in the context of the present invention, refers to the composition that is present inside the microcapsules. For electro-optic display applications comprising an electrophoretic media, the microcapsules may comprise at least one type of charged pigment particles in a non-polar fluid. The electrophoretic medium may comprise one type of charged pigment particles or more than one type of charged pigment particles, each type of particles having different colors, charges and charge polarities. The charged pigment particles move through the electrophoretic medium under the influence of an electric field, the electric field being applied across the electro-optic material layer. The charged pigment particles may be inorganic or organic pigments having polymeric surface treatments to improve their stability. The electrophoretic medium may comprise charged pigment particles having white, black, cyan, magenta, yellow, blue, green, red, and other colors. The electrophoretic medium may also comprise, charge control agents, charge adjuvants, rheology modifies, and other additives. Examples of non-polar fluids include hydrocarbons such as Isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-corning (DC-200).

The electrophoretic medium may comprise two or more types of charged pigment particles. The electrophoretic medium may comprise four types of charged pigment particles, a first, second type, third type, and fourth types of charged pigment particles. The first, second, third, and fourth types of charged pigment particles may comprise a first, second, third, and fourth types of pigment, having a first, second, third, and fourth color, respectively. First, second, third, and fourth colors may be different from each other. The first type of charged pigment particles may comprise inorganic pigment and has a first charge polarity. The second and third types of charged pigment particles may have a second charge polarity that is opposite to second charge polarity. The fourth type of charged pigment particles may have first charge polarity or second charge polarity. The first type of charged pigment particles may be white. The second, third, and fourth charged pigment particles may have colors selected from the group consisting of cyan, magenta, and yellow.

FIGS. 3A and 3B summarize an example of part of the method of manufacturing an electro-optic display 100 via electro-optic assembly 200 (Front Plane Laminate). A first electrode layer 101 is provided and, in Step 1 of FIG. 3A, an aqueous microcapsule slurry (not shown in FIG. 3A) is applied onto a surface of first electrode layer 101. The electro-optic material slurry is dried to form an electro-optic material layer 102 on first electrode layer 101. In Step 2 of FIG. 3A, an adhesive composition 114 is applied onto the electro-optic material layer 102 to form an adhesive layer 104. In the resulting structure, the electro-optic material layer 102 is disposed between the first electrode layer 101 and the adhesive layer 104. In Step 3 of FIG. 3A, a release sheet is connected onto the adhesive layer 104 to form a Front Plane Laminate 200. The adhesive layer 104 in Front Plane Laminate 200 is disposed between the electro-optic material layer 102 and the release sheet 105.

Front Plane Laminate 200 can be used to form electro-optic display 100 of the present invention as shown in FIG. 3B. Specifically, in Step 4 of FIG. 3B, the release sheet 105 is removed, exposing the adhesive layer 104. Onto the exposed adhesive layer 104, a backplane can be a attached to form electro-optic display 100. The backplane comprises a second electrode layer (not shown in FIG. 3B). The second electrode layer may comprise a plurality of pixel electrode.

### EXAMPLES

### Example 1: Preparation of Electrophoretic Medium

Electrophoretic medium was prepared by the combination of four charge pigment particle dispersions, that is a white charge pigment particle dispersion in Isopar E, a cyan charge pigment particle dispersion in Isopar E, a magenta charge pigment particle dispersion in Isopar E, and a yellow charge pigment particle dispersion in Isopar E. Charge control agent CCA-111 and polyisobutylene were added into the combined dispersion under agitation providing the electrophoretic medium. The structure and preparation of CCA-111 was described in United States Application with Publication No. 2020/0355978.

### Example 2A: Preparation of Aqueous Microcapsule Dispersion

The electrophoretic medium from Example 1, was encapsulated in a gelatin/acacia coacervate using the following method. Gelatin is dissolved in deionized water at a temperature of 40° C., and vigorously stirred. The electrophoretic medium from Example 1 was added dropwise to the stirred gelatin solution through a tube the outlet of which is below the surface of the stirred solution. The resultant mixture was held at 42.5° C. with continued vigorous stirring to produce droplets of the electrophoretic medium in a continuous gelatin-containing aqueous phase. A solution of acacia in water at 42.5° C. was then added to the mixture, and the pH of the mixture is lowered to approximately 5 to cause formation of the gelatin/acacia coacervate, thereby forming microcapsules. The temperature of the resultant mixture is then lowered to 9° C. and an aqueous solution of glutaraldehyde (cross-linking agent) was added. The resultant mixture was then warmed to 25° C. and stirred vigorously for 12 hours. The capsules produced were separated by sieving, using sieves of 20 micrometers and 45 micrometers mesh size, to obtain capsules with a mean diameter of about 44 micrometers.

### Example 3A: Preparation of Aqueous Microcapsule Dispersion Comprising a Biocide

Into the aqueous microcapsule dispersion of Example 2A, biocide Proxil TN was mixed into the dispersion. The weight ratio of microcapsules:Biocide was 370:1. The weight of microcapsules that was used to calculate the ratio did not include the water medium of the aqueous microcapsule dispersion.

### Example 4A: Preparation of Aqueous Microcapsule Slurry

Into the aqueous microcapsule dispersion from Example 2A, cationic poly(vinyl alcohol) was added and mixed to form an aqueous microcell slurry. The weight ratio of microcapsules to the amount of the cationic poly(vinyl alcohol) binder was 1:0.06. The weight of microcapsules that was used to calculate the ratio did not include the water medium of the aqueous microcapsule dispersion. The final aqueous microcapsule slurry contained 60% water. The cationic poly(vinyl alcohol) was supplied by Kuraray under the commercial code CM-318.

### Example 5A: Preparation of Aqueous Microcapsule Slurry Comprising a Biocide

Into the aqueous microcapsule slurry of Example 4A, biocide Proxil TN was mixed into the dispersion. The weight ratio of microcapsules:Biocide was 370:1. The weight of microcapsules that was used to calculate the ratio did not include the water medium of the aqueous microcapsule slurry.

Comparative Example 2B: The aqueous microcapsule dispersion from Example 2A was stored at 25° C. for 24 weeks.

Comparative Example 3B: The aqueous microcapsule dispersion from Example 3A was stored at 25° C. for 24 weeks.

Example 4B: The aqueous microcapsule slurry from Example 4A was stored at 25° C. for 24 weeks.

Example 5B: The aqueous microcapsule slurry from Example 5A was stored at 25° C. for 24 weeks.

Before the storage period of 24 weeks at 25° C., a microcapsule was extracted from each of the samples of Examples 2A, 3A, 4A, and 5A and the burst force or the extracted microcapsule was determined by nanoindentation test. After the storage period of 24 weeks at 25° C., a microcapsule was extracted from each of the samples of Comparative Example 2B, Comparative 3B, Example 4B, and Example 5B and the burst force of the extracted microcapsule was determined by nanoindentation test. In addition, before the storage period of 24 weeks at 25° C., the pH values of the aqueous microcapsule dispersion of Examples 2A and 3A were measured. After before the storage period of 24 weeks at 25° C., the pH values of the aqueous microcapsule dispersion of Comparative Examples 2B and 3B were measured. The results of the pH values are summarized in Table 1. The results of the burst force of the extracted microcapsule are summarized in Table 2.

### Method of Determination of Burst Force of a Microcapsule.

A microcapsule was removed from the aqueous microcapsule dispersion or from the aqueous microcapsule slurry and placed on the sensor of Hyistron TI 750 Ubi Triboscope. The burst force was determined by nanoindentation test in load-controlled feedback mode. The test is performed by applying a force to drive the indenter probe into the sample surface and then reducing the force to withdraw the probe. The applied load and indenter displacement into the sample were continuously monitored. The results are reported in microNewton/micrometers (μN/μm).

TABLE 1
Summary of pH values of Aqueous Microcapsule
Dispersion Compositions Before and After
Storage at 25° C. for 24 weeks.

| | | Is Biocide | pH Before | pH After |
|---|---|---|---|---|
| Example | Sample Type | Included? | Storage | Storage |
| Ex. 2A | Aqueous | No | 8.5 | |
| | microcapsule | | | |
| | dispersion | | | |
| Comparative | Aqueous | No | | 7.6 |
| Ex. 2B | microcapsule | | | |
| | dispersion | | | |
| Ex. 3A | Aqueous | Yes | 9.0 | |
| | microcapsule | | | |
| | dispersion | | | |
| Comparative | Aqueous | Yes | | 8.9 |
| Ex. 3B | microcapsule | | | |
| | dispersion | | | |

TABLE 2
Summary of Microcapsule Burst Force of Aqueous Microcapsule
Dispersion Compositions and Aqueous Microcapsule Slurry Compositions
Before and After Storage at 25° C. for 24 weeks.

| | | | Microcapsule | Microcapsule |
|---|---|---|---|---|
| | | Is | Burst Force | Burst Force |
| | | Biocide | Before Storage | After Storage |
| Example | Sample Type | Included? | (μN/μm) | (μN/μm) |
| Ex. 2A | Aqueous | No | 244 | |
| | microcapsule | | | |
| | dispersion | | | |
| Comparative | Aqueous | No | | 224 |
| Ex. 2B | microcapsule | | | |
| | dispersion | | | |
| Ex. 3A | Aqueous | Yes | 239 | |
| | microcapsule | | | |
| | dispersion | | | |
| Comparative | Aqueous | Yes | | 195 |
| Ex. 3B | microcapsule | | | |
| | dispersion | | | |
| Ex. 4A | Aqueous | No | 207 | |
| | microcapsule slurry | | | |
| | (microcapsules and | | | |
| | binder) | | | |
| Ex. 4B | Aqueous | No | | 236 |
| | microcapsule slurry | | | |
| | (microcapsules and | | | |
| | binder) | | | |
| Ex. 5A | Aqueous | Yes | 230 | |
| | microcapsule slurry | | | |
| | (microcapsules and | | | |
| | binder) | | | |
| Ex. 5B | Aqueous | Yes | | 199 |
| | microcapsule slurry | | | |
| | (microcapsules and | | | |
| | binder) | | | |

Table 2 shows that, in aqueous samples aged for 24 weeks at 25° C., the higher pH that is caused by the biocide (in Examples 3B and 5B), the burst force was lower than in the samples that do not contain biocide (Examples 2B and 4B). This demonstrated the detrimental effect that the traditional, small molecule biocide has on the integrity of the microcapsules. The conditions of higher pH may have resulted in some hydrolysis of the material of the microcapsule wall, causing the lower burst force for breaking the microcapsules. The highest burst force was observed in inventive Example 5B, which was aged as an aqueous microcapsule slurry, which contains a polymer containing one or more quaternary ammonium functional groups, and which does not contain a biocide.

### Comparative Example 2C: Preparation of Electro-Optic Display Preparation of Electro-Optic Display from Aqueous Microcapsule Dispersion 2B

The aqueous microcapsule dispersion of Example 2B that was stored at 25° C. for 24 weeks was mixed with the cationic poly(vinyl alcohol) binder to prepare as aqueous microcapsule slurry. The aqueous microcapsule slurry had a weight ratio of microcapsules to binder of 1:0.06. The weight of microcapsules that was used to calculate the ratio did not include the water medium of the aqueous microcapsule dispersion. The aqueous microcapsule slurry was used to prepare an electro-optic display comprising a first electrode layer, an electro-optic mater layer, an adhesive layer, and a second electrode layer. For comparison, an electro-optic display was also prepared from the aqueous microcapsule dispersion of Example 4A (before its storage at 25° C.). This electro-optic display can be considered the control for display of Example 2C at zero time. The electro-optic performance of the electro-optic displays were evaluated by determining their total color gamut.

### Comparative Example 3C: Preparation of Electro-Optic Display from Aqueous Microcapsule Dispersion 2C

The aqueous microcapsule dispersion of Example 3B that was stored at 25° C. for 24 weeks was mixed with the cationic poly(vinyl alcohol) binder to prepare as aqueous microcapsule slurry. The aqueous microcapsule slurry had a weight ratio of microcapsules to binder of 1:0.06. The weight of microcapsules that was used to calculate the ratio did not include the water medium of the aqueous microcapsule dispersion. The aqueous microcapsule slurry was used to prepare an electro-optic display comprising a first electrode layer, an electro-optic mater layer, an adhesive layer, and a second electrode layer. For comparison, an electro-optic display was also prepared from the aqueous microcapsule dispersion of Example 5A (before its storage at 25° C.). This electro-optic display can be considered the control for display of Example 3C at zero time. The electro-optic performance of the electro-optic displays were evaluated by determining the total color gamut.

### Example 4C: Preparation of Electro-Optic Display from Aqueous Microcapsule Slurry 3C

The aqueous microcapsule slurry of Example 4B that was stored at 25° C. for 24 weeks was used to prepare an electro-optic display comprising a first electrode layer, an electro-optic mater layer, an adhesive layer, and a second electrode layer. For comparison, an electro-optic display was also prepared from the aqueous microcapsule dispersion of Example 4A (before its storage at 25° C.). This electro-optic display can be considered the control for display of Example 4C at zero time. The electro-optic performance of the electro-optic displays were evaluated by determining their total color gamut.

### Example 5C: Preparation of Electro-Optic Display from Aqueous Microcapsule Slurry 5B

The aqueous microcapsule slurry of Example 5B that was stored at 25° C. for 24 weeks was used to prepare an electro-optic display comprising a first electrode layer, an electro-optic mater layer, an adhesive layer, and a second electrode layer. For comparison, an electro-optic display was also prepared from the aqueous microcapsule dispersion of Example 5A (before its storage at 25° C.). This electro-optic display can be considered the control for display of Example 5C at zero time. The electro-optic performance of the electro-optic displays were evaluated by determining their total color gamut.

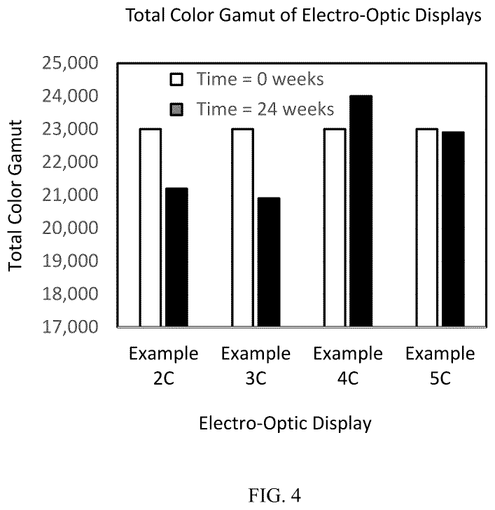

The total color gamuts of the electro-optic displays of Examples 2C, 3C, 4C, 5C and the corresponding control electro-optic displays (at zero time) are provided in Table 3 and FIG. 4.

### Method of Color Gamut Measurement.

The electro-optic displays from Comparative Examples 2C, 3C, and Examples 4C, and 5C were evaluated by determining the color gamut of the displays before aging (T=0) and after aging for 24 weeks at 25° C. The electro-optic displays from Comparative Examples 2C, 3C, and Examples 4C, and 5C were electrically driven to generate eight optical states. The electrophoretic devices were addressed using sequences of electrical pulses (such sequences being referred to as a “waveform”). In the following description, the voltages used in the waveform are those supplied to the rear electrodes of the display, assuming that the electrode at the front (viewing) surface of the display is a first electrode to all pixels and is connected to ground. The color state of the display (measured in CIELab L*, a* and b* units) was recorded. The color gamut of each display was measured by computing the volume of the convex hull containing every colored state produced by the set of testing waveforms. The eight color states generated were red, green, blue, yellow, cyan, magenta, white, and black (R, G, B, Y, C, M, W, and K). The color gamut is reported in DE³ units. Broader color gamut, that is, larger space, means better electro-optic performance of the electro-optic device.

TABLE 3
Color Gamut of Electro-Optic Devices

| | Color Gamut at | Color Gamut at |
|---|---|---|
| Electro-Optic Display | T = 0 weeks | T = 24 weeks |
| Comparative Example 2C | 23,000 | 21,200 |
| Comparative Example 3C | 23,000 | 20,900 |
| Example 4C | 23,000 | 24,000 |
| Example 5C | 23,000 | 22,900 |

For electro-optic displays of Comparative Example 2C and 3C, the electro-optic material layer of which were prepared using aqueous microcapsule dispersions of Comparative Examples 2B and 3B (without and with biocide) that were stored at 25° C., a moderate decrease of color gamut was observed after 24 weeks. Possibly, the inferior performance of the electro-optic device of Comparative Example 3C was caused by undesirable reactions occurring because of the higher pH of the aqueous microcapsule dispersion because of the presence of the biocide, as shown in Table 1. In addition, the inferior performance may be caused by the presence of the mobile biocide, which is a small organic molecule able to migrate into different parts of the electro-optic material layer (or other layers of the display).

The electro-optic displays (Examples 4C and 5C) that were prepared from aqueous microcapsule slurries that were stored at 25° C. did not show significant decrease in color gamut. The polymer of the binder that contains quaternary ammonium functional groups may act as an antimicrobial material without the detrimental effect of the smaller biocide molecule. As observed before (Comparative Example 3C versus Comparative Example 2C), the electro-optic display that comprises biocide (Example 5C) has slightly inferior electro-optic performance than that of the electro-optic display of Example 4C, which does not contain a biocide.

Finally, aqueous microcapsule dispersion sample of Comparative Example 2B, after storage for 24 weeks at 25° C., and the corresponding aqueous microcapsule slurry of Example 4B, after storage for 24 weeks at 25° C., were evaluated for bacterial growth using BD Hycheck by incubating aliquots of samples at 37° C. for 3 days. After the 3-day incubation period, 5% the surface that was coated by the aliquot of Comparative Example 2B was covered by bacteria colonies, whereas no bacteria colonies were observed for the surface that was coated by the aliquot of Example 5B. Likely, the presence of the cationic poly(vinyl alcohol) prevent bacteria growth in the sample of Example 5B. The method involves coating of the aqueous sample onto a Hycheck slide, followed by incubation at 37° C. for 3 days.

What is claimed is:

1. An electro-optic display comprising, in order:
a first electrode layer comprising a light-transmissive electrode;
an electro-optic material layer comprising a plurality of microcapsules dispersed in a binder, each microcapsule of the plurality of microcapsules comprising an electrophoretic medium, the electrophoretic medium comprising a plurality of charged pigment particles, and a non-polar liquid, the binder comprising a polymer containing one or more quaternary ammonium functional groups in its molecular structure;
a second electrode layer comprising a plurality of pixel electrodes.

2. The electro-optic display of claim 1, wherein the electro-optic material layer is substantially free from biocide.

3. The electro-optic display of claim 1, wherein the binder comprises a poly(vinyl alcohol) containing one or more quaternary ammonium functional groups in its molecular structure.

4. The electro-optic display of claim 3, wherein the weight average molecular weight of the poly(vinyl alcohol) is from 1,000 to 1,000,000 Daltons.

5. The electro-optic display of claim 3, wherein the poly(vinyl alcohol) is crosslinked.

6. The electro-optic display of claim 3, wherein the poly(vinyl alcohol) contains from 0.03 to 0.4 quaternary ammonium functional groups for every vinyl alcohol unit of the polymer.

7. The electro-optic display of claim 3, wherein the poly(vinyl alcohol) contains from 0.05 to 0.2 quaternary ammonium functional groups for every vinyl alcohol unit of the polymer.

8. The electro-optic display of claim 3, wherein the poly(vinyl alcohol) is soluble in water.

9. The electro-optic display of claim 3, wherein the degree of hydrolysis of the poly(vinyl alcohol) is from 80 to 99.5.

10. The electro-optic display of claim 1, wherein the binder comprises a polyurethane containing one or more quaternary ammonium functional groups in its molecular structure.

11. The electro-optic display of claim 10, wherein the weight average molecular weight of the polyurethane is from 1,000 to 2,000,000 Daltons.

12. The electro-optic display of claim 10, wherein the polyurethane is water soluble or water dispersible.

13. The electro-optic display of claim 10, wherein the polyurethane is crosslinked.

14. The electro-optic display of claim 10, wherein the polyurethane is selected from the group consisting of polyether polyurethane, polyester polyurethane, and polycarbonate polyurethane.

15. The electro-optic display of claim 1, wherein the electro-optic material layer comprises from 85 weight percent to 97 weight percent microcapsules, and from 15 weight percent to 3 weight percent binder by weight of the electro-optic material layer.

16. The electro-optic display of claim 1, wherein the electrophoretic medium comprises four types of charged pigment particles, a first type of charged pigment particles, a second type of charged pigment particles, a third type of charged pigment particles, and a fourth type of charged pigment particles, each type of charged pigment particles have a color that is different from the colors of all other types of charged pigment particles.

17. The electro-optic display of claim 16, wherein the electrophoretic medium further comprises a fifth type of charged pigment particles.

18. The electro-optic display of claim 16, wherein the colors of the first, second, third, and fourth charged pigment particles is selected from the group consisting of white, black, yellow, cyan, magenta, green, blue, and red.

19. The electro-optic display of claim 16, wherein the first type of charged pigment particles is negatively charged, and the second, third, and fourth types charged pigment particles is positively charged.

20. A method of manufacturing an electro-optic display, the method of manufacturing comprising the steps:
providing an aqueous dispersion of a plurality of microcapsules, each microcapsule of the plurality of microcapsules comprising an electrophoretic medium, the electrophoretic medium comprising a plurality of charged pigment particles, and a non-polar liquid;
mixing an aqueous binder solution or dispersion and the aqueous dispersion of a plurality of microcapsules forming an aqueous microcapsule slurry, the binder solution or dispersion comprising a polymer containing one or more quaternary ammonium functional groups in its molecular structure;
providing a first electrode layer comprising a light-transmissive electrode, the first electrode layer having a surface;
applying the aqueous microcapsule slurry onto the surface of the first electrode layer to form an aqueous microcapsule layer;
drying the aqueous microcapsule layer to form an electro-optic material layer on the first electrode layer;
applying an adhesive composition onto the electro-optic material layer to form an adhesive layer, the electro-optic material layer being disposed between the first electrode layer and the adhesive layer;
connecting a release sheet onto the adhesive layer to form a Front Plane Laminate, the adhesive layer in the Front Plane Laminate being disposed between the electro-optic material layer and the release sheet;
removing the release sheet, exposing the adhesive layer;
attaching a backplane onto the exposed surface of the adhesive layer, the backplane comprising a second electrode layer.
